(19) United States
(12) Patent Application Publication
(10) Pub. No.: US 2015/0363553 A1
(43) Pub. Date: Dec. 17, 2015

(54) MEDICAL REGISTRY

(71) Applicants: Naryan L. RUSTGI, Villanova, PA (US); Sanjay Kumar KUNCHAKARRA, Clarksville, MD (US); Neil Shivraj DAVEY, Gaithersburg, MD (US); Rajet VATSA, Scottsdale, AZ (US); Sujay Madapur SWAIN, Gaithersburg, MD (US); Sonya R. DAVEY, Gaithersburg, MD (US)

(72) Inventors: Naryan L. RUSTGI, Villanova, PA (US); Sanjay Kumar KUNCHAKARRA, Clarksville, MD (US); Neil Shivraj DAVEY, Gaithersburg, MD (US); Rajet VATSA, Scottsdale, AZ (US); Sujay Madapur SWAIN, Gaithersburg, MD (US); Sonya R. DAVEY, Gaithersburg, MD (US)

(21) Appl. No.: 14/836,253

(22) Filed: Aug. 26, 2015

Related U.S. Application Data
(63) Continuation-in-part of application No. 13/920,100, filed on Jun. 18, 2013.

(51) Int. Cl. G06F 19/00; G06F 17/30

(52) U.S. Cl. CPC G06F 19/322; G06F 17/30342; G06F 17/30424; G06F 17/30867; G06F 19/363; G06F 19/3425

(57) ABSTRACT

An embodiment relates to a computer implemented system for correlating medical data, the system comprising: first module comprising a first algorithm configured to collect patient inputted data provided by a first patient through a user device in communication with the first module; a second module comprising a second algorithm configured to collect data from one or more databases in communication with the second module; a social network electronic communication platform comprising a social network algorithm configured to create a social network environment that allows a plurality of patients, including the first patient, to interact and collaborate with each other; a storage medium for storing data collected from at least the first and second modules; at least one processor, which is in communication with the social network electronic platform, configured to correlate the patient inputted data with data from the one or more databases and communicate a result based on correlating the patient inputted data with data from the one or more databases to the first patient.

### RELATED APPLICATIONS

The present application is a continuation-in-part of U.S. application Ser. No. 13/920,100, entitled “Medical Registry,” filed on Jun. 18, 2013, which is incorporated herein in its entirety by reference. All US patents, applications and publications referred to herein are incorporated herein in their entirety by reference.

### BACKGROUND

Several databases for capturing research associated with cancer exist in the medical research industry.

### SUMMARY

Medical Registry such as a Cancer Registry enables the following:
Capture data directly from patients throughout the life cycle i.e., from disease diagnosis, treatment and post treatment life style information
Collect information from existing knowledge and clinical trial databases
Collect information from Doctor's office patient medical records (although, patient data may need to be de-identified and internal review boards may be needed to validate and authenticate the patient data)
Combine and correlate data all of the above three sources

The data from clinical trials and other research studies includes only a limited set of patients. However, a Cancer Registry, for example, potentially could contain data associated with several millions patients. The database that contains patients' data in such large numbers provides a unique opportunity to develop and continuously refine medical diagnosis, therapy and management, for example, for cancer, as well as treatment models including effectiveness of various treatment drugs.

In addition, the MedicalRegistry offers the following features to patients:
Connect and enable patients to search on case studies of patients with similar profiles
Interact and collaborate with patients of similar interest through social media platforms
Provide personalized recommendations to patients on lifestyle patterns including diet, exercise and stress relief mechanisms during the post treatment recovery process
Provide patients with an early detection system that cross references the patient's medical condition with new studies and publications

Medical Registry will be an extremely useful platform for researchers as well as doctors providing the following services:
Provide tools and platform to analyze patients data by research scientists
Provide tools and platform to collaborate on disease mitigation

### BRIEF DESCRIPTION OF FIGURES

FIG. 1: Depicts an illustrative schematic of the high level components associated with Medical Registry such a Cancer Registry according to an embodiment.

FIG. 2: Depicts an illustrative schematic of the patient, researcher or doctor registry input according to an embodiment.

FIG. 3: Depicts an illustrative schematic of undesirable data mitigation system according to an embodiment according to an embodiment.

FIG. 4: Depicts an illustrative schematic of the logical system architecture of Medical Registry such as the Cancer Registry according to an embodiment.

FIG. 5: Depicts an illustrative schematic of the patient service functional architecture according to an embodiment.

FIG. 6: Depicts an illustrative schematic of the patient lifestyle recommendation service of Medical Registry such as the Cancer Registry according to an embodiment.

FIG. 7: Depicts an illustrative schematic of the patient matching service of Medical Registry such as the Cancer Registry according to an embodiment.

FIG. 8: Depicts an illustrative schematic of layered breakdown of researcher services of Medical Registry such as the Cancer Registry according to an embodiment.

FIG. 9: Depicts an illustrative schematic of the technical architecture of Medical Registry such as the Cancer Registry according to an embodiment.

FIG. 10: A schematic of a component of the medical registry that allows for the exchange of data in a structured, uniformly codified, and interoperable manner from different databases.

FIG. 11: A schematic showing that a patient can use several sensor modules, capable of monitoring critical vital signs, such as, temperature, respiration, inclination, blood pressure, blood sugar, etc.

### DETAILED DESCRIPTION

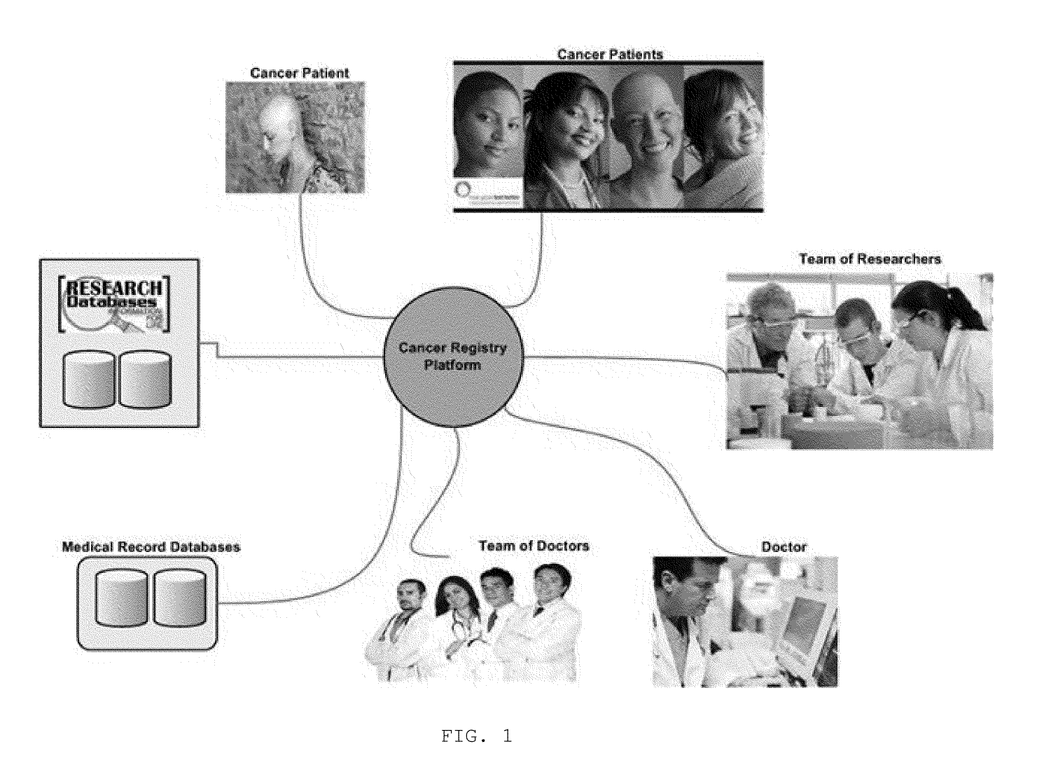

As shown in FIG. 1, the following types of users interact with Medical Registry such as the Cancer Registry Platform:

a) Patients such Cancer Patients

b) Scientists such as Cancer Research Scientists

c) Health Care Providers including Doctors

Below we describe a Medical Registry for cancer.

### Cancer Patient Interaction

A patient is able to access the platform by inputting their credentials, which are then authenticated to allow access. Once the patient has entered the platform, they can enter their data and optionally use the platform's social network capabilities to interact with other individuals who may be experiencing similar symptoms or illnesses as them. In addition, Cancer Registry provides personalized lifestyle recommendations.

### Cancer Research Scientists

Cancer Registry Platform enables the scientists to enter data and search, analyze and correlate the data from three distinct sources including Cancer Registry's Patients data, external Cancer Research Repositories and Cancer Patients medical records from doctor's office.

### Health Care Providers

Cancer Registry Platform enables the doctor's and other health care providers to enter data and perform searches and understand patients' feedback on various treatment technologies. In addition, it provides a wealth of information on lifestyle recommendations that can be prescribed to patients during the post treatment recovery periods.

### Patients Data Capture Flow

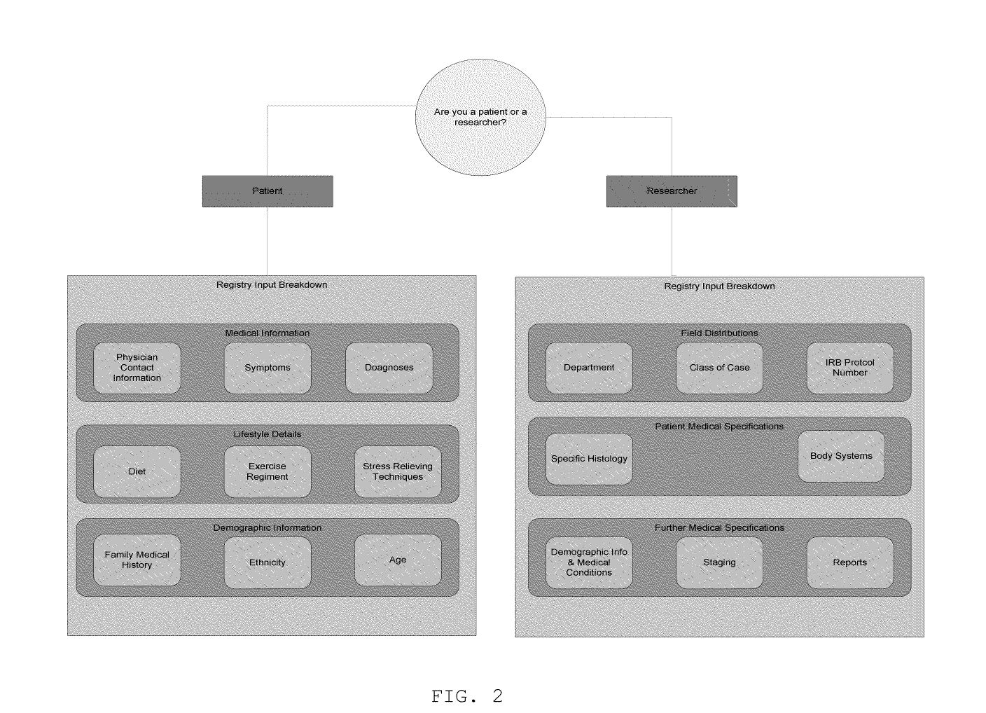

The information that every patient inputs, for example, to create their profile within the social network platform, such as demographic information and medical history, is referred to as structured patient reported data and is stored in a database within Medical Registry such the cancer registry platform. The information that patients provide, for example, in the social network, through comments and discussions is known as unstructured patient reported data as seen in FIG. 2.

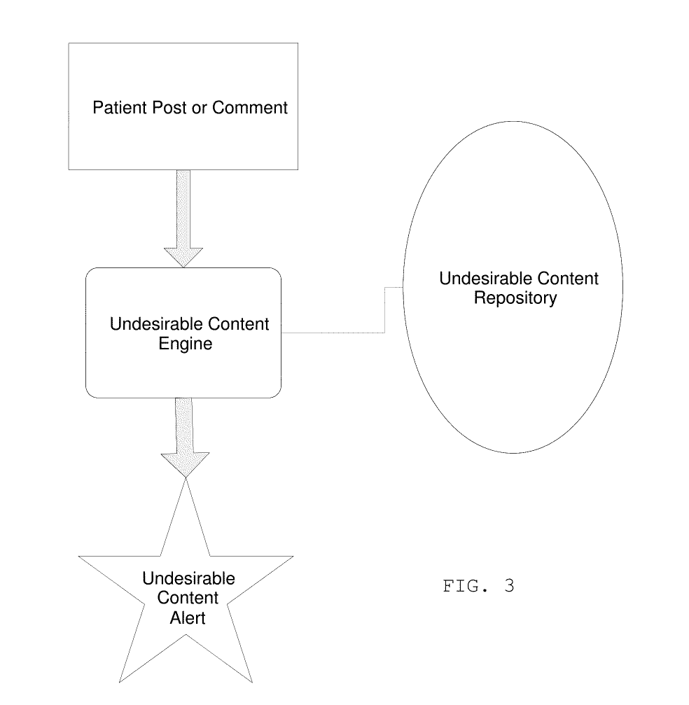

As the primary source of data for the platform, the patient reported data has the potential for extreme error because it is impossible to control the patient's understanding and judgment in what they report. However this platform will have the capability of filtering to some extent both the structured and unstructured patient reported data. The flowchart depicted in FIG. 3 illustrates the method for detecting unreliable unstructured patient reported data. Any time a patient publishes a status or comments on a post through, for example, the platform's social network capabilities, they gain the ability to influence others. But because these patients are not trained medical professionals, their advice is not always sound. The method above relies on a pre-existing set of undesirable words or phrases such as “smoking reduces the risk of cancer.” The text in every comment or post is analyzed and cross-referenced with the undesirable phrases data set to determine if the post contains fallacious information. If an undesirable phrase is detected within the post, the post will be flagged to signal other users that the information contained within the post is erroneous.

The platform will also have the capability of monitoring and filtering structured patient data as well. When patients are inputting their demographic information and their medical condition, pre-programmed limitations, which are boundaries that define a framework of the medical registry input service, will be implemented. For example, if a person labels himself as male, the platform will not allow the patient to say that he has ovarian cancer. Limitations such as these ensure that illogical data is not entered into the database and used for analytical purposes.

### Conceptual Architecture

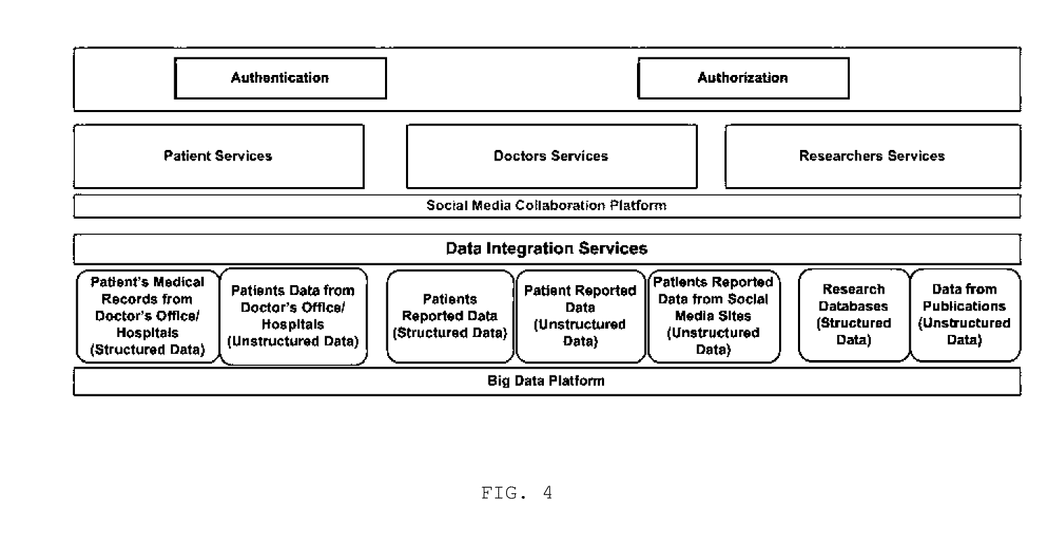

FIG. 4 provides a layered breakdown of the cancer registry platform. The initial step is the authentication of every user. Whether you are a patient, physician, researcher, non-physician health-care provider, or insurance provider, every person enters his or her credentials into the platform. Those credentials are then authenticated providing the user with access to the platform.

The platform is separated into at least three different service segments, a patient services segment, a doctor services segment, and a researcher services segment. Optionally, there could be an insurance provider service segment. A service segment is a grouping of applications specified to one type of user. Based on what type of user you are, you will be provided with a specific set of services. Patients will also be able to communicate with one another through the social media platform (for example by blogging and any future derivatives of blogging), and they will have applications within the platform that services just them. Similarly, doctors will be able to interface with one another, but will have individualized applications available to them. Researchers will be able to communicate with their peers personally as well as professionally as they will get updates of their peer's research activity, such as publishing a study or beginning a drug trial. Researcher Services will primarily consist of analytic tools that combine information from the multitude of data sources within the platform to illustrate trends in disease development or occurrences of drug side effects appearing across an extremely large population.

The data used for the above mentioned services segments are integrated through data integration services. The primary sources of data that the data integration services will use to power the patient, doctor, and researcher services are the structured and unstructured patient reported data, structured and unstructured research data, and structured and unstructured medical data. The structured patient reported data is all the information that patients input when answering the registry questionnaire questions (i.e. demographic info and medical history). There are two sources of unstructured patient data. One being self-reported diagnoses that cannot be considered entirely accurate and the other being all the information accumulated throughout the social network through patient conversations, comments and monitored activity. Structured doctor reported data is essentially all the information doctors input regarding official patient records. Unstructured doctor reported data would come from extracted comments and conversations physicians have on the social media platform. Structured Researcher data is all the information contained within the research database such as publications and studies from academic institutions around the world and current databases.

All the information compiled and gathered is stored within a Big Data Platform. When an application in the patient, doctor, or research services is launched, data is extracted from the big data platform and is analyzed for a specific task through the data integration service. The output information will be relayed back to the patient, doctor, or researcher.

Both the unstructured and structured patient reported data is analyzed and cross referenced with information from other databases. For example, the other databases could include current research and academic databases such as PubMed. The patient reported data is used to power an engine that searches for publications relevant to the patient's condition. The publications that are identified are then provided to the patient as suggested reading. The patient reported data regarding medical history and symptoms are verified to a degree by cross-referencing them with another database storing physicians' medical records.

When a patient creates an account for the first time, a unique object will be created for the patient, which is stored in the registry database. Similarly, when a physician enters information regarding a specific patient, a unique object is created which is stored in the medical record database (structured doctor data). The main platform will then compare the attributes of the two corresponding objects and create an alert if there is a discrepancy.

Optionally, just like the patients gain access to their own social networking platform, physicians and researchers will also have the ability to interact with their peers in same or different social networking platforms. Within a social networking platform, three account types can be available, one for patients, one for physicians, and one for researchers. Researchers will be able to observe what recent studies and publications their peers in similar research settings have completed, increasing the flow of communication between research organizations around the world.

### Patient Services

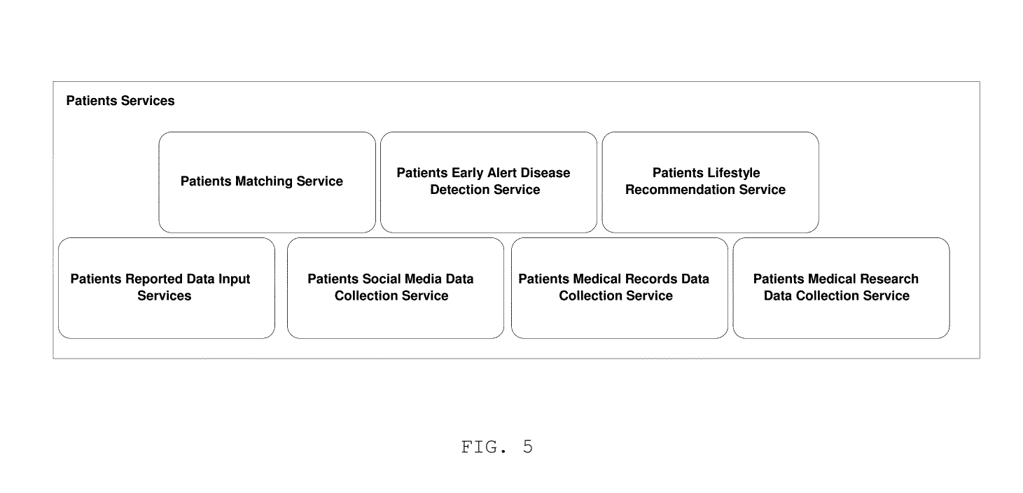

FIG. 5 provides a deeper look into the patient services as touched on before. As previously mentioned when a patient logs on to the platform, they will have access to both a social media platform and individualized services. The components of these individualized services are, for example, a lifestyle recommendation service and a patient matching service, which are powered by the patient reported data (structured and unstructured), the structured doctor reported data (medical records), and the structured research data (medical databases).

An embodiment of the patient services is the Lifestyle recommendation service, which will be expanded on further. Essentially this engine will pull information from the patient reported database, research publications, and medical records to provide patients facing medical issues with a comprehensive lifestyle regiment that includes a specified diet, exercise, and stress relieving techniques that help patients recover and deal with illnesses beyond prescribed medication.

Another embodiment of the patient services is the Patients Matching service. The patient matching service essentially provides each patient with profiles of others who are experiencing similar symptoms or illnesses. One purpose of this service is to simply establish communication channels between individuals who may want to talk with others who are going through the same medical conditions and procedures that they are such as chemotherapy or transplants. These social channels provide patients with much needed comfort as they begin physically exhausting medical procedures. Patients who have yet to receive a diagnosis for their symptoms can be paired with others who are experiencing similar symptoms. If a patient discovers somebody in a similar situation they are in who has been diagnosed with a certain disease, it could provide that patient with an idea of what could be causing his or her symptoms. This allows patients access to the wealth of data within this registry, which can be used as a potential differential diagnosis system for a patient unable to find a suitable diagnosis from conventional doctors. The matching service pulls from the patient reported data and from doctor reported data in medical records to check for similarities in demographics and symptoms between patients.

Another embodiment of the patient services is an early detection system that alerts patients when they may have a certain illness. This engine compiles the structured and unstructured patient reported data and cross-references it with new medical studies that illustrate potential relationships between diseases. For example, if a person says that he has diabetes and says that he is beginning to experience high blood pressure and high cholesterol, an alert will be provided to the patient informing him that due to his condition of diabetes and the fact that these symptoms have signaled heart conditions in other patients, this person may be at risk for heart disease.

### Patient Lifestyle Recommendation Service

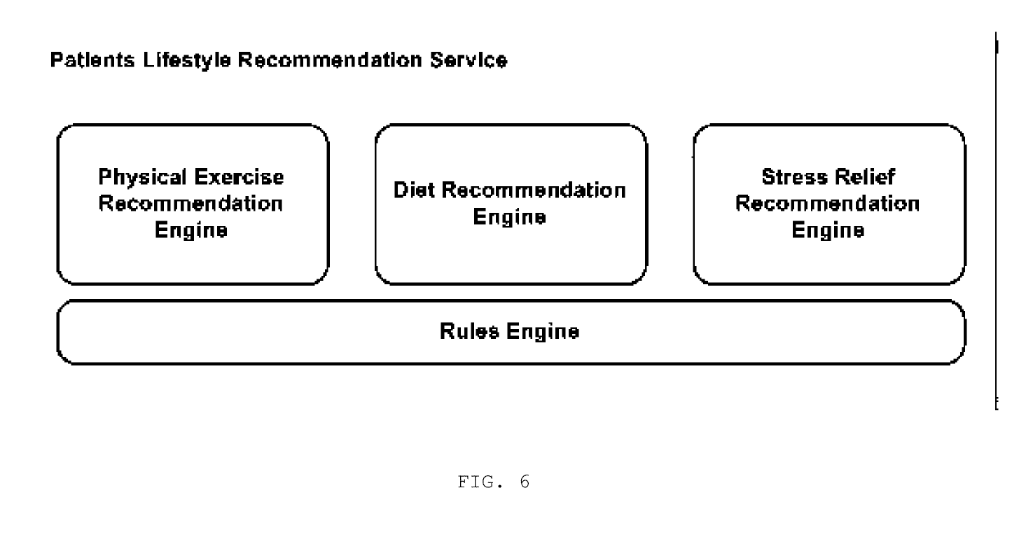

The goal of the patient's lifestyle recommendation engine is to provide patients with a holistic set of guidelines to live by during disease recovery. Once a patient is released from the hospital or are trying to cope with a disease, often they aren't given much instruction on how to appropriate eat, exercise, etc. in order to keep their body healthy and prevent other diseases from surfacing. Once patients input their symptoms and/or diagnoses along with completing a personality questionnaire, the engine provides the patients with exercise regiments, dietary guidelines, and stress relief techniques, each individualized to the patient's particular conditions and personality traits as depicted in FIG. 6.

The first mechanism that provides patients with an individualized lifestyle recommendation is the extraction of information from the medical publications database. As new studies are being published illustrating how, for example, certain forms of exercise can help in the recovery from heart cancer, the lifestyle recommendation engine compiles these studies to create an algorithm that controls the rules engine. If a patient enters in their demographic information, claiming that he is a middle-aged male with heart disease, the rules engine will take those pieces of information (male, middle-aged, and heart disease) and utilize the preset algorithm to generate an appropriate exercise and diet regiment for the patient.

The second mechanism used to generate a lifestyle recommendation is the extraction of information from the physician records database. Along with just the patients demographic data, doctors can also add in notes or suggestions they have regarding the patients exercise or dietary habits. For example, a physician might note, if his patient had problems with heart disease, to avoid eating too much red meat. All the notes and suggestions that doctors include will be synthesized to increase the capabilities of the rules engine. Instead of simply generating exercise and diet regiments through relationships identified in biological studies, the entirety of physicians' notes in the records database will be complied to establish relationships between medical condition and exercise/dietary requirements (i.e., patients with heart disease shouldn't eat red meat). The third mechanism used to generate recommendation output is through the analysis of patient reported data. The analysis of unstructured patient reported data (i.e. comments and thread discussions) can also illustrate relationships between medical condition and exercise/diet/stress relieving techniques. As opposed to the analysis of controlled medical experiments or suggestions provided by qualified professionals, patient reported data can be erroneous and requires methods of filtration to ensure quality results. However, the mass of data itself is extremely powerful and harnessing it to detect

Trends or relationships that may not appear in small controlled experiments can yield results that will advance the rules engine.

The patient lifestyle recommendation engine will also be implemented with a self-improvement system. When the engine initially outputs dietary/exercise/stress relieving regiments based on the patients' initial input, the engine will then later record the patient's change in medical condition to evaluate the effectiveness of the provided treatment. Doing so will self-correct the algorithm used to generate lifestyle recommendations.

### Patient Matching Service

One feature of the platform is a service that links patients together based on medical condition and symptoms. This service is used for medical or social purposes to allow for those experiencing similar medical issues to talk with one another about how they deal with the situation. This technology can also be used to link patients up that have not received a diagnosis yet but are experiencing similar symptoms. Often times, rare occurrences of diseases are difficult to pin point, but if a large mass of people are located in one place, and a common symptom is found amongst several people, it could help understand what underlying disease is causing the symptom, speeding up the process of receiving a diagnosis.

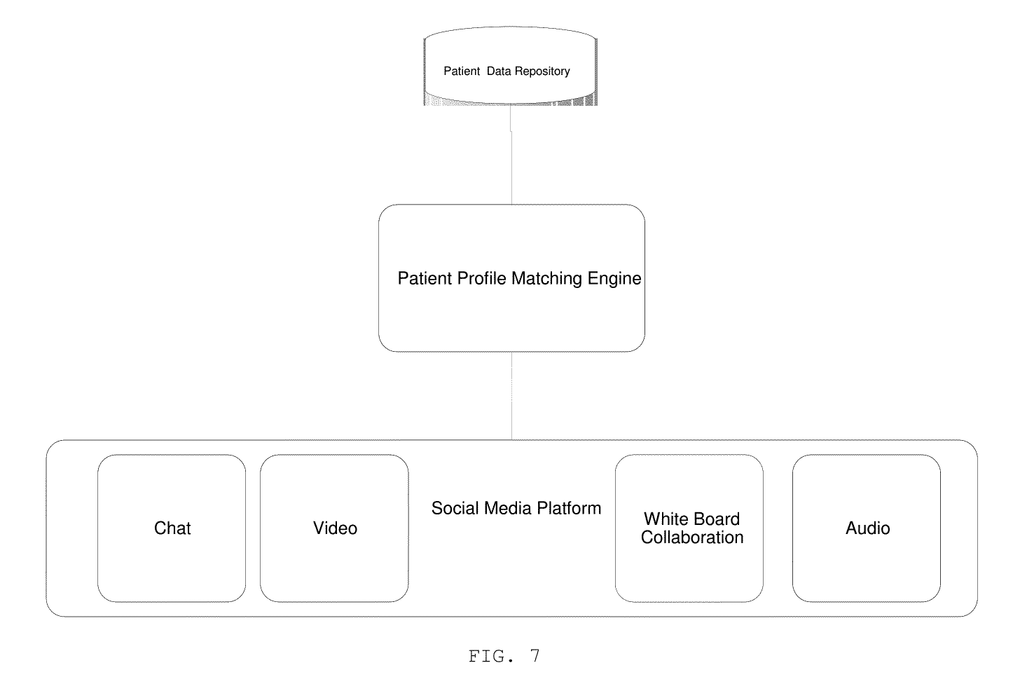

The method for doing so, as depicted in FIG. 7, begins with a patient accessing the patient filtration server. This service essentially extracts the patient's data from the database within the cancer registry platform and utilizes the similarity engine to cross reference that patient's data with all the structured and unstructured data within the cancer registry database. When similarities in demographic information and symptoms/medical condition are detected, the patient is provided with the profile of other individuals with similar profiles.

### Researchers Services

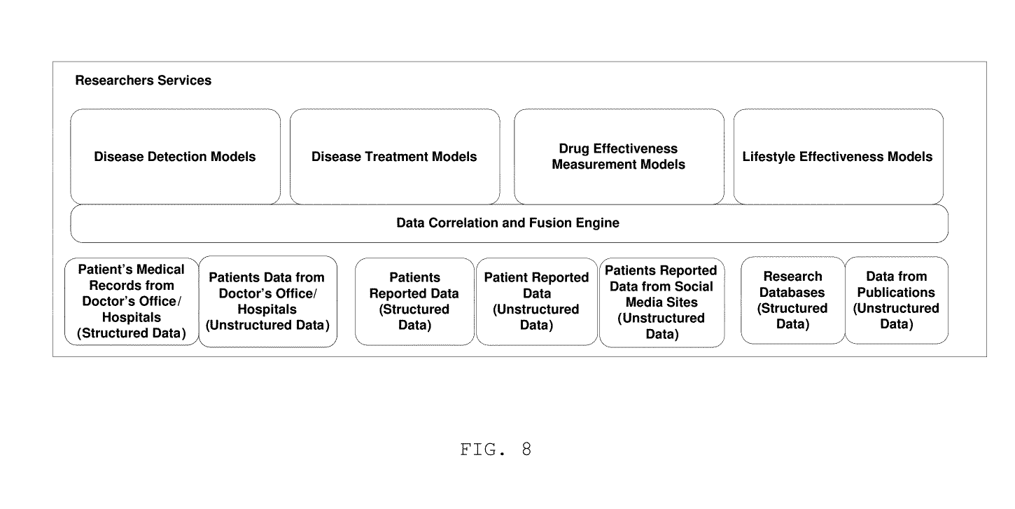

As noted before, the wealth of data stored within this platform provides an unprecedented opportunity for researchers to observe, analyze and measure the development of diseases. The platform will contain, as depicted in FIG. 8, analytics through the data correlation and fusion engine that compile the patient and physician data to construct epidemiological models on a scale that will allow for the faster detection of epidemic developments, spurning both new research and a quicker medical response.

The data in the system also can illustrate the effectiveness of drug and pharmaceutical treatments. As patients and physicians report medicinal information along with their medical conditions, the data engine can illustrate the side effects and the effectiveness of drugs among a population much larger than any test group or clinical study.

As new research illustrates how certain treatment models affect disease recovery, the patients' response to the lifestyle recommendations shed light on the effectiveness of the recommendations and can point to new areas of research that can be explored.

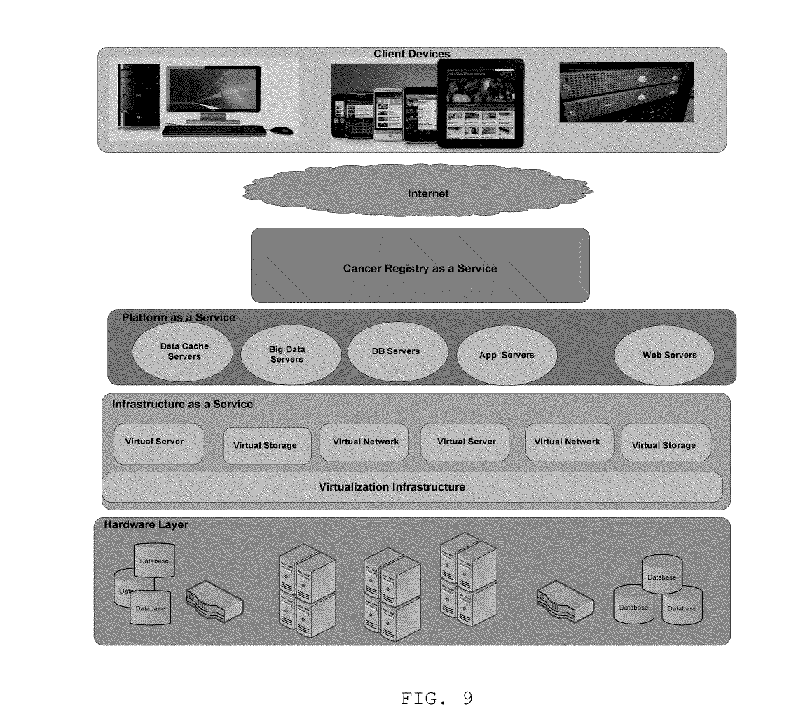

### Technical Architecture (FIG. 9)

Infrastructure as a Service (IaaS):

The Medical Registry such as the Cancer Registry System will be hosted on industry proven cloud platform such as Amazon cloud. This will allow for increasing computing capacity through virtualization. This will enable the registry platform to have unlimited amount of computing capacity as the demand increases.

Platform as a Service (PaaS):

The Medical Registry such as the Cancer registry system will be developed on standard platforms hosted by cloud providers. To begin the platform will be developed on open source platforms including as Apache Web Servers, Apache Tomcat, and Postgres databases. In addition, it will fully utilize the latest distributed computing platforms such as Apache Hadope hosted on Amazon EC2 cloud.

Software as a Service (SaaS):

The Medical Registry such as the Cancer registry system will be architected and designed from the ground up as Software as a Service so that multiple users groups and segments can share the same software without encountering any issues of privacy and security.

### Example 1

An embodiment relates to a computer implemented system for correlating medical data, the system comprising a module configured to collect patient inputted data provided by a patient; a module configured to collect data from a database; a storage medium for storing data collected from a plurality of modules; at least one processor configured to correlate the patient inputted data with data from one or more databases, wherein the medical registry would correlate data inputted by the patient with data existing on the database for the purpose of patient matching. The medical registry and/or components of the medical registry such as the Patient Lifestyle Recommendation Service may generate real time (e.g., hourly, daily, weekly, monthly, or yearly) reports on a given patient and send these reports to the given patient or to a group of patients sharing data through a social network electronic communication platform comprising a social network algorithm configured to create a social network environment that allows a plurality of patients, including the given patient, to interact and collaborate with each other.

Such a platform would allow for a variety of patients with similar medical conditions to interact with one another and potentially share disease treatment/control strategies with one another. Simultaneously, such a social network would act as a support system for individuals with shared experiences who can empathize with one another. Additionally, the database could match patient inputted symptoms with confirmed diagnoses of other patients for the purpose of mutual disease diagnosis. FIG. 7 details this architecture at a high level.

The details of the social network that could be used for such patient interaction are referenced in the published patent application US 2012/0209694 A1 entitled “Virtual Communication Platform,” which is incorporated herein in its entirety by reference. After being matched with another patient, contact details could be requested through multiple streams of social media, including Facebook, Gmail, Twitter, LinkedIn, etc. Given the fragmentation existing today between various forms of virtual communication, our universal platform (as referenced in US 2012/0209694 A1 FIG. 2) would connect these fragmented streams of social media and include functionalities such as simple chat, video communication, web-based audio, white-board collaboration, and music/gaming (see US 2012/0209694 A1 FIG. 3).

An embodiment herein relates to medical registry wherein a social network environment is configured to allow a plurality of patients to interact and collaborate with each other. This embodiment differs from US 2010/0070306 A1 entitled “Patient Community System With Anonymized Electronic Medical Data,” which is incorporated herein in its entirety by reference, in that our more comprehensive platform would not only allow patients with similar conditions to communicate with one another through text, speech, and video, but also allow them to share disease control/treatment strategies through a white-board application and potentially interact more casually in a gaming or music-sharing environment to create a stress-free atmosphere. FIG. 9 details the technical architecture of the cloud computing software through which the cancer registry database and virtual communication platform will operate.

Other embodiments relate to the medical registry, wherein the system is configured to provide personalized recommendations to patients on lifestyle patterns or wherein the lifestyle patterns include diet, exercise and stress relief. In addition to connecting patients with similar medical indications to one another, an important functionality of the medical registry would be to provide personalized recommendations to patients on lifestyle patterns including diet, exercise, and stress relief. More specifically, when a patient enters data regarding symptoms/diagnoses on the registry, the engine would comb through an amalgam of data previously inputted from researchers, physicians, and other patients to deliver a comprehensive lifestyle recommendation report to the patient. The report will be personalized for specific conditions entered by the initial user, providing the most up-to-date suggestions from medical publications by researchers, previous patient interactions by doctors, and unstructured day-to-day advice from other patients. The recommendation report will update every 24 hours given new medical literature, additional recorded doctor-patient interactions, and more patient-inputted data. Lifestyle recommendations should also adjust real-time according to conditions entered by the patient.

The above other embodiments differ from US 2010/0076786 A1 entitled “Computer System and Computer-Implemented Method for Providing Personalized Health Information for Multiple Patients and Caregivers,” which is incorporated herein in its entirety by reference, in that the personalized lifestyle recommendation is not only coming from a plurality of patients and clinical data from healthcare providers, but also from researchers deeply invested in the field. Such a process is described in more detail in FIG. 15 of published patent US 2013/0241719 A1 entitled “Virtual Communication Platform for Healthcare,” in which patients, after inputting certain parameters about their diagnosis, receive advisory data from current scientific literature.

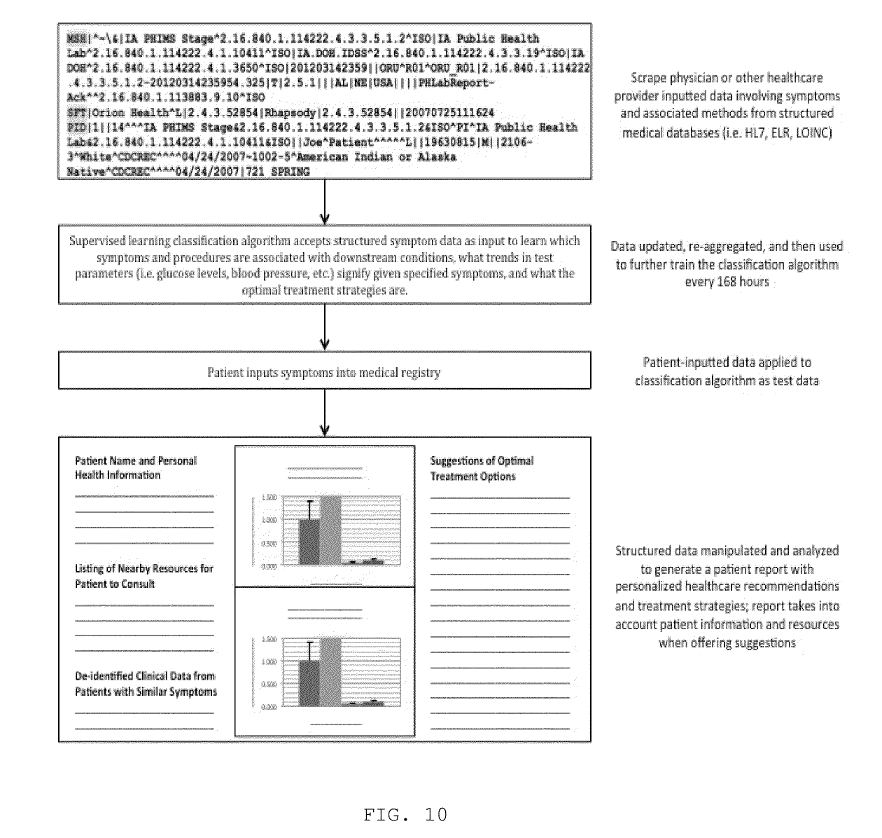

Yet another embodiment relates to better addressing the reviewer's point and providing additional unique information about “stress relief” recommendations, which could a part of the mechanism of the Patient Lifestyle Recommendation Service. With respect to this embodiment, with permission from the patient user, data obtained through the virtual communication platform would be used to provide further recommendations by the medical registry and/or health care providers. For example, analysis of the patient's typing speed/pressure, facial expressions, tone of voice, and/or pupillary dilations can be done by the software during social interactions between patients, and this data can be combined and sent to the medical provider. Thus, the patient's affect and cognitive features are being analyzed during chats, audio communication, and video calls to get a better understanding of the patient's mental state and provide even more accurate lifestyle recommendations to the patient. This process is described extensively in US 2013/0254287 A1 entitled “Online Social Interaction, Education, and Health Care by Analyzing Affect and Cognitive Features” (particularly FIGS. 10-12), which is incorporated herein in its entirety by reference. Such emotion recognition software built into the platform would allow recommendations to be given not only based on intentionally inputted data, but also based on unintentional actions that are still voluntary and recorded by the software. Typing, speech, and video analysis can be vitally revealing in terms of patient mental health state. This functionality of the medical registry would significantly improve lifestyle recommendations specific to stress relief, as the computer in some ways is acting as a monitoring psychologist.

### Example 2

An embodiment relates to a computer implemented system for correlating medical data, the system comprising a module configured to collect patient inputted data provided by a patient; a module configured to collect data from an existing data bank; a storage medium for storing data collected from a plurality of modules; at least one processor configured to correlate the patient inputted data with data from one or more databases, further comprising a module configured to collect a physician and/or other healthcare provider inputted data provided by a physician and/or other healthcare provider, wherein the physician and/or other healthcare provider inputted data include symptoms.

A component of the medical registry is to allow for the exchange of data in a structured, uniformly codified, and interoperable manner from different databases as shown in FIG. 10. Especially given the system comprising a module configured to collect a physician and/or other healthcare provider inputted data provided by a physician and/or other healthcare provider, in which a module is configured to collect physician and/or other healthcare provider inputted data, the absence of technical and semantic standards, such as the increasingly accepted Meaningful Use (MU) criteria, could substantially impede the efficient delivery of clinical results, tracking and accurate exchange of medical information, and quality of data analytics for patients. Thus, the data inputted by healthcare providers to the medical registry would obey defined standards such as ELR (Electronic Laboratory Reporting) for the electronic transmission of laboratory data to public health databases, HL7 (Health Level 7) for the structured exchange and retrieval of other electronic health information, etc. Furthermore, the use of standardized and structured vocabularies like LOINC (Logical Observation Identifiers Names and Codes) for basic clinical results and SNOMED CT (Systematized Nomenclature of Medicine—Clinical Terms) for more comprehensive clinical records would significantly enhance the automation and aggregation of clinical data. As the data encoded in associated LOINC, ELR, or HL7 databases follows a highly specified format—including information about the facility in which symptoms are assessed, the software used to transmit data, patients' demographics, order requests and detailed results for corresponding clinical tests, etc.—a comprehensive training data set could then be compiled by scraping those repositories. Once the training set is sufficiently large, a supervised learning classification algorithm using decision trees could then be implemented to translate physician-inputted clinical data regarding symptoms and associated clinical procedures into meaningful information for patients.

This is specifically where the feature “wherein the physician and/or other healthcare provider inputted data include symptoms” differs from the patent publication US 2010/0076786 A1 entitled “Computer System and Computer-Implemented Method for Providing Personalized Health Information for Multiple Patients and Caregivers,” which is incorporated herein in its entirety by reference. In particular, our more comprehensive platform would convert the structured clinical data into graphical data that patients could then observe and analyze within the medical registry. FIG. 1 details the technical architecture of this method, in which the structured medical data—including symptoms assessed, tests ordered, parameters measured, timings of procedures conducted and costs of treatment—are scraped from various databases, used to train the machine learning algorithm, and then exported in an accessible manner for patients. Thus, whenever a patient enters their symptom information into the medical registry, the backend classification algorithm will identify the most likely condition based on the healthcare provider-inputted training set, generate a personalized report for the patient displaying clinical trends in previous cases, and then suggest the most effective care options given that patient's information (geographic location for determining nearby resources, financial capabilities, etc.). The highly structured and codified nature of the physician-inputted data, as detailed above, would potentiate the efficient aggregation of such vast datasets and downstream manipulation and analysis of that data to most effectively assist patients. Thus, this functionality of the medical registry would significantly streamline the use of clinical data involving symptoms and associated methods for the development of personalized healthcare recommendations and treatment strategies.

### Example 3

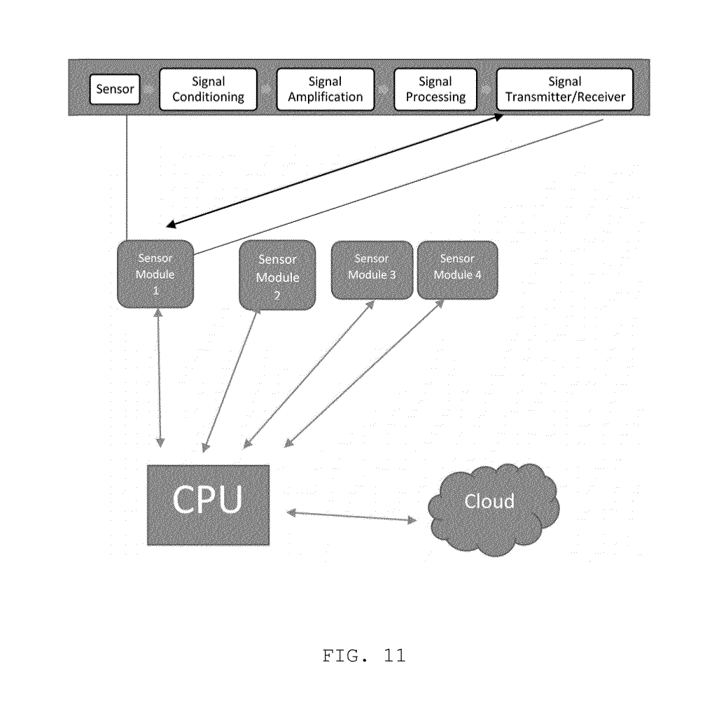

In another embodiment, a patient can use several sensor modules, capable of monitoring critical vital signs, such as, temperature, respiration, inclination, blood pressure, blood sugar, etc. as shown in FIG. 11. Each sensor module (shown as Sensor Modules 1 to 4) will be equipped with, within the sensor module or remote from the sensor module, a signal pre-conditioning circuit, that will continuously filter the measured noise and only monitor actual signals, an amplification circuit that will amplify the signal, an on-board micro-controller, that will process the information as needed, an wireless transceiver that can transmit and receive the data as needed to a central micro-processor unit (CPU). In one embodiment, one or all of the sensor, the signal conditioner, the signal amplifier, signal processor and wireless transceiver are remote from the sensor module, as shown in FIG. 11. For example, in another embodiment, the sensor module could include the sensor, while the signal conditioner, the signal amplifier, signal processor and wireless transceiver are remote from the sensor module. In such embodiments where the transceiver is remote from the sensor module, the remote wireless transceiver would be in contact wireless communication with the sensor module either intermittently or continuously as shown by the double-headed arrow in FIG. 11.

Each sensor module will be in constant communication with the central micro-processor unit (CPU). A typical system schematic is shown in FIG. 11. The different sensor modules are capable of communication between each other, if needed, such that Sensor Module 1 can communicate with Sensor Modules 2 to 4, vice versa.

The CPU will have the necessary intelligence to perform relevant analysis based on one's nominal vital sings as agreed by the personal physician and previous data. As a given set of vital signs deviate from the nominal value by a pre-determined amount (say +/−5%), the CPU will flag this event and send a query to the medical registry database. Depending on the specific signature of the anomaly, as agreed upon by experts, the patient will receive either an advisory for a consultation at his/her convenience or a serious warning for immediate medical attention. Every such warnings, associated symptoms and background information will be up loaded to the medical registry, resident on a cloud database, for future reference by the patient in particular or other uses in general as relevant. Although, the sensors do not directly communicate with each other, when a sensor notices an abnormality in a specific vital sign and sends that information to the CPU, the CPU sends a ping to see if there are one or more patterns that can be correlated with any of the other vital signs as measured by other sensors.

The sensor assembly module-1 can be configured to measure human body temperature by choosing appropriate sensor capable of measuring human body temperature. The sensor assembly makes use of a thermistor, an amplifier, several resistors, and capacitor. This sensor can be used as a wearable device to continuously measure body temperature or be used to measure temperature periodically.

### Signal Conditioning:

Under normal operation, the temperature sensor, as it measures the body temperature, will encounter many noise sources. These noise sources will pose significant challenge for meaningful interpretation of required information. Output of this sensor must be processed to remove any noise and thus allow only required signal. The processer can be any type of data processer chip that is sold by TI, Microchip, or, Broadcom.

Most analog signals require some form of preparation before they can be digitized. Signal conditioning is the manipulation of a signal in a way that prepares it for the next stage of processing. Many applications involve environmental or structural measurement, such as temperature and vibration, from sensors. These sensors, in turn, require signal conditioning before a data acquisition device can effectively and accurately measure the signal. For example, thermocouple signals have very small voltage levels that must be conditioned and amplified before they can be digitized. A typical signal after the signal conditioning operation has been performed is shown in FIG. 11 (above the signal conditioning block). As shown in FIG. 11, the raw signal from the temperature sensor (thermistor), has several noise sources mixed with it.

The signal conditioning circuit makes use of several techniques such as filtering and stochastic analysis. The proposed approach performs a real-time regression analysis, to identify noises from the actual signal. Depending on the types of noise (Fixed pattern noise, short noise, telegraphic noise, random noise, etc.), a specific filtration technique is applied that subtracts this noise from the raw signal. Subsequently it will be amplified using the on board amplifier. Signal conditioning ICs are available from many venders, such as, TI, Maxim, Microchip, Signal Amplification:

An amplifier (often loosely called an “amp”) is an electromagnetic or electronic component that boosts an electric signal. A transistor-based amplifier takes the signal (the input) and boosts it many times before feeding it into the next processing step (output). The effect of an amplifier is measured by a factor called the gain of the amplifier. Gain is defined as the ratio of output divided by input.

Depending on the specific nature of the signal, one of the many types of possible amplifier design can be selected. No amplifier design is perfect in every respect or perfectly suited for every application. When one chooses an amplifier for a particular application, he/she always compromising on something—either gain, linearity or efficiency. Apart from being classified by things like voltage, power, current, and frequency, or their end-use, amplifiers are often also classified using letters of the alphabet (typically A to D), which, broadly speaking, classifies a certain amplifier for optimum linearity, efficiency, or a compromise between them both. For the temperature sensor circuit using a thermistor, as described in our FIG. 11, a class AB amplifier that optimizes the linearity, power consumption, cost as well as size is a very good choice.

Such amplification chips can also be obtained from TI or Broadcom. The signal processing circuit will make use of any modern integrated circuit fabricated by companies such as Texas Instrument or Microchip. The output signal will be wirelessly transmitted to the system CPU which will be in constant communication with the cloud database. The CPU makes use of existing infrastructure, such as smart phones, tablets, laptops, etc. This data can be viewed from devices that act as the CPU.

### Signal Processing:

Signal processing is an enabling technology that encompasses the fundamental theory, applications, and implementations of processing or transferring information contained in many different physical, symbolic, or abstract formats broadly designated uses as signal. Depending on the types of input signal, specific processing technique, such as, analog signal processing, discrete time signal processing, digital signal processing or non-linear signal processing method will be used.

As the signal from the amplification circuit is fed into the processing unit, depending on the nature of the signal, the processing unit adopts one of the above techniques. For our specific instance of thermistor based sensor where the input signal is mostly analog, the signal processing circuit will adopt an analog signal processing method.

### Signal Flow Analysis (Interaction Between Modules):

As the raw signal from the sensor module (body temperature as measured by the thermistor in this case) is fed into the signal conditioning unit, the first thing the conditioning unit does is to look for various noise elements, such as, random noise spikes, fixed pattern noise, etc. As presence of such noises is detected, using on board processing capability, these noises are filtered out. As the noises get filtered out, the subtracted signal (free of noise), needs to be amplified such that it can be meaningfully fed into the analog to digital converter (A-to-D) for proper digitization. Care has to be taken to ensure that this amplification is done as noiselessly as possible. The output signal is then passed onto the signal processing unit which further processes the data depending on specific agreed upon strategy. For instance, this processing unit has been assigned certain limits (upper and lower limits) as agreed upon by prior medical record or individual physician's recommendation. Instead of transmitting the data continuously (that can consume significant amount of energy and hence reduce battery life), using the upper and lower limit as stored in the signal processing unit, only when the data exceeds these limits, such data is transmitted. This strategy saves tremendous amount of energy and extends the battery life. Such data can eventually be sent to the system CPU for subsequent processing such as uploading to cloud as needed.

The signal conditioning, signal amplification and signal processing technique as described above for the temperature sensor can also be applied to all other sensors for measuring vital signs.

Typical signal after the signal amplification and processing operation has been performed is shown above or below the respected circuit block in FIG. 11. The signal processing block has a high and low value which represents the baseline created by the CPU using the information from the cloud and sends it to the sensor, so that it can detect any abnormalities.

Another sensor module that can be used is to measure heart rate. One can have a sensor that you wear on your wrist. This is constantly measuring your heartbeat. Then it will condition the data and amplify it as needed. Using data from the cloud gathered from medical reports and previous data, it will create a baseline for you. That data will the wirelessly sent to the CPU allowing for CPU to send out data of importance. The CPU is in constant communication with the database which means that it can update the data base with information and get the most accurate information at any time.

Yet another sensor to measure blood sugar. Using the newer smart watches which can measure vital signs such as blood sugar, one can take your blood sugar at all times. Then it will condition the data and amplify the data. Using data from the cloud gathered from medical reports and previous data, it will create a baseline for you. This is especially good for people with diabetes because this is not as uncomfortable as the older more bulky devices. Then, the data will be wirelessly sent to the CPU allowing for CPU to send out data of importance. The CPU is in constant communication with the database which means that it can update the data base with the information and get the most accurate information at any time. Also, if the doctor has an update for the patient, the doctor can upload those to the cloud that the patient can have them ready to use.

What is claimed is:

1. A computer implemented system for correlating medical data, the system comprising:
a first module comprising a first algorithm configured to collect patient inputted data provided by a first patient through a user device in communication with the first module;
a second module comprising a second algorithm configured to collect data from one or more databases in communication with the second module;
a social network electronic communication platform comprising a social network algorithm configured to create a social network environment that allows a plurality of patients, including the first patient, to interact and collaborate with each other;
a storage medium for storing data collected from at least the first and second modules;
at least one processor, which is in communication with the social network electronic platform, configured to correlate the patient inputted data with data from the one or more databases and communicate a result based on correlating the patient inputted data with data from the one or more databases to the first patient.

2. The system of claim 1, further comprising a third module comprising a third algorithm configured to collect physician and/or other healthcare provider inputted data provided by a physician and/or other healthcare provider.

3. The system of claim 2, wherein the at least one processor is further configured to correlate the patient inputted data with the physician and/or other healthcare provider inputted data.

4. The system of claim 1, wherein the one or more databases includes data from clinical trials.

5. The system of claim 1, further wherein the at least one processor communicates the result to the social network electronic communication platform after receiving permission from the first patient to transmit the result to the social network electronic communication platform.

6. The system of claim 1, wherein the system is configured to provide personalized recommendations to patients on lifestyle patterns.

7. The system of claim 6, wherein the lifestyle patterns include diet, exercise and stress relief.

8. The system of claim 1, wherein the system is configured to provide disease diagnosis based on correlation between data provided by the first patient and data available on one or more databases.

9. The system of claim 2, wherein the physician and/or other healthcare provider inputted data include symptoms.

10. The system of claim 1, wherein the system is configured to filter out certain data before correlating patient data from a plurality of data sources.

11. The system of claim 10, wherein the system is further configured to correlate data based on past history of the first patient

12. The system of claim 1, further comprising a fourth module comprising a fourth algorithm configured for audio and/or visual data input and/or output.

13. A tangible non-transitory computer readable medium comprising computer executable instructions executable by one or more processors for implementing one or more operations in a computer implemented system for correlating medical data, the computer implemented system comprising:
a first module comprising a first algorithm configured to collect patient inputted data provided by a patient through a user device in communication with the first module;
a second module comprising a second algorithm configured to collect data from one or more databases in communication with the second module;
a social network electronic communication platform comprising a social network algorithm configured to create a social network environment that allows a plurality of patients, including the first patient, to interact and collaborate with each other;
a storage medium for storing data collected from at least the first and second modules;
a storage medium for storing data collected from at least the first and second modules;
at least one processor, which is in communication with the social network electronic platform, configured to correlate the patient inputted data with data from the one or more databases and communicate a result based on correlating the patient inputted data with data from the one or more databases to the first patient.

14. The tangible non-transitory computer readable of claim 13, further comprising a third module comprising a third algorithm configured to collect physician and/or other healthcare provider inputted data provided by a physician and/or other healthcare provider.

15. The system of claim 14, wherein the at least one processor is further configured to correlate the patient inputted data with the physician and/or other healthcare provider inputted data.

16. A method comprising implementing one or more operations in a computer implemented system for correlating medical data, the computer implemented system comprising:
a first module comprising a first algorithm configured to collect patient inputted data provided by a patient through a user device in communication with the first module;
a second module comprising a second algorithm configured to collect data from one or more databases in communication with the second module;
a social network electronic communication platform comprising a social network algorithm configured to create a social network environment that allows a plurality of patients, including the first patient, to interact and collaborate with each other;
a storage medium for storing data collected from at least the first and second modules;
a storage medium for storing data collected from at least the first and second modules;
at least one processor, which is in communication with the social network electronic platform, configured to correlate the patient inputted data with data from the one or more databases and communicate a result based on correlating the patient inputted data with data from the one or more databases to the first patient.

17. The method of claim 16, further comprising a third module comprising a third algorithm configured to collect physician and/or other healthcare provider inputted data provided by a physician and/or other healthcare provider.

18. The method of claim 17, wherein the at least one processor is further configured to correlate the patient inputted data with the physician and/or other healthcare provider inputted data.

19. The system of claim 1, wherein the computer implemented system for correlating medical data is configured to send one or more reports to the first patient in real-time.

20. The system of claim 1, wherein the computer implemented system for correlating medical data is configured to send one or more reports to the plurality of patients in real-time.
